(19) United States
(12) Patent Application Publication
(10) Pub. No.: US 2010/0132965 A1
(43) Pub. Date: Jun. 3, 2010

(54) May-30

(76) Inventor: Paul Kevin Lawrence, Rowlett, TX (US)

Correspondence Address: PAUL K. LAWRENCE, 9110 WESTFIELD DR., ROWLETT, TX, 75088, US

(21) Appl. No.: 12/315,103

(22) Filed: Nov. 28, 2008

(51) Int. Cl. A62C 31/00

(52) U.S. Cl. 169/70

(57) ABSTRACT

The May 30° is a 6′ play pipe made out of 1½″ aluminum pipe. At the bottom end of the play pipe is a on/off Valve and at the top end is a heavy duty brass Industrial Fog nozzle. This tool has a 30° bend in front of the nozzle. It is light weight, so the firefighters can work with this tool with ease.

### FIELD OF THE INVENTION

The present invention relates to a firefighter being able to cool down the air temperature around the corner in a structure where needed. This can be done safely by them using this tool.

### SUMMARY AND A BRIEF DESCRIPTION OF THE INVENTION

The May-30° is a firefighters tool to use during the fighting of a fire. This is a 6′ play pipe made out of 1½″ aluminum pipe, has an on/off valve and a heavy duty brass Industrial Fog nozzle. This tool has a 30° bend in front of the nozzle, so firefighters to spray the air around a corner safely to cool the air temperature down were the firefighters can safely go threw that area.

### THIS IS A BRIEF DESCRIPTION OF THE DRAWINGS

FIG. 1 shows a view of the May-30° right side.

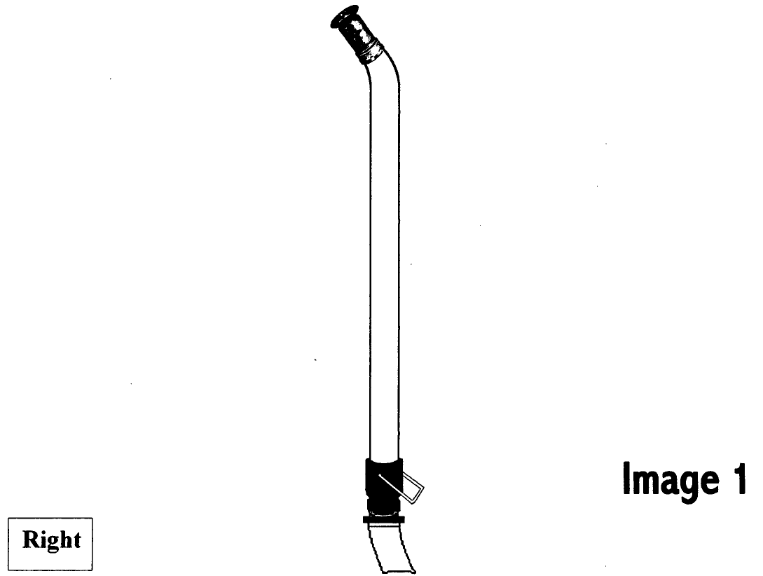

FIG. 2 is the left side view of the tool.

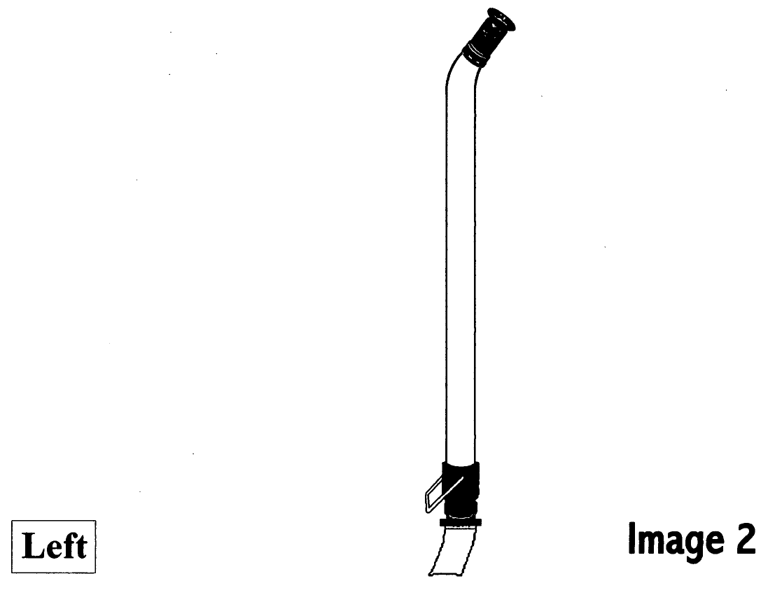

FIG. 3 is the front view of the tool.

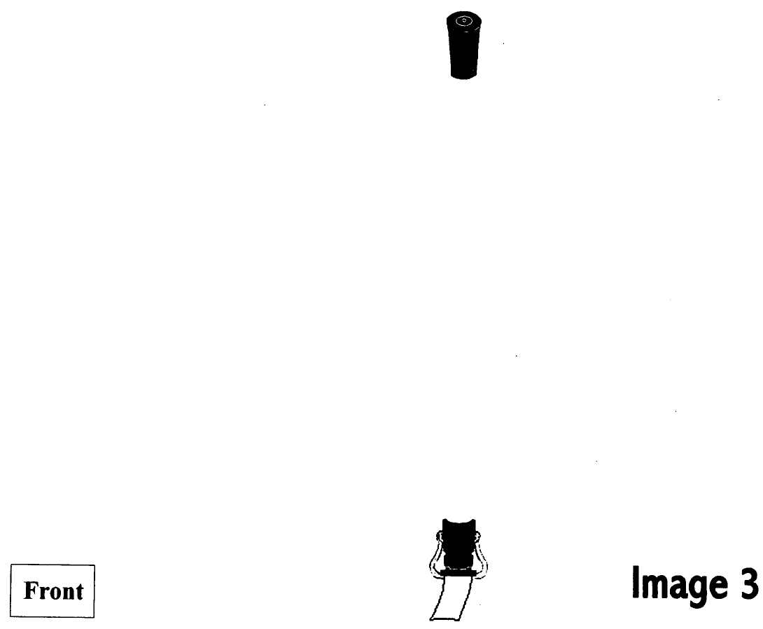

FIG. 4 is the back view of the tool.

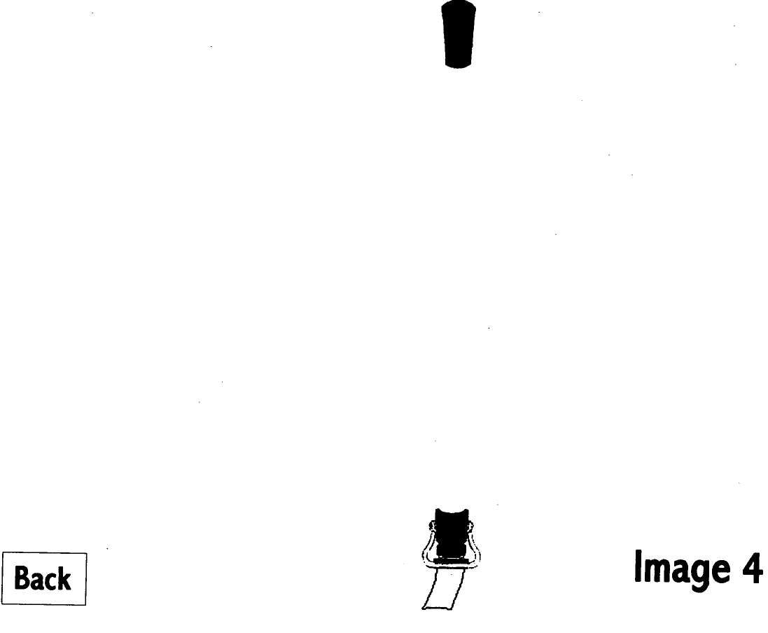

### DETAILED DESCRIPTION OF INVENTION AND DESCRIPTION OF THE PREFERRED EMBODIMENT

As to the manner of usage and operation of the invention it is preferred to be used by firefighters to use during the fighting of a fire. They will use it to spray the air around a corner safely to cool the air temperature down were the firefighters can safely go threw that area.

To make the May-30° used a 6′ long peace of 1½″ aluminum pipe and put 1½″ long American standard threads on both ends of the Play Pipe both being male thread joint and put a 30° bend on one end. On the 30° bend end screw on a heavy duty brass Industrial Fog nozzle. On the other end that is straight screw on a on/off valve.

What is claimed is:

1. This will help a fireman from getting into an emergency by keeping the Fireman from having to pock their head up in the ceiling of a burring structure. This will also ad the Fireman in which the Fireman can extinct the fire of a burring structure, by allowing them to go to the necessary rooms and quickly pocking the May into the ceiling and applying the needed solvent onto the burring materiel.
